(19) United States
(12) Patent Application Publication
(10) Pub. No.: US 2024/0021061 A1
(43) Pub. Date: Jan. 18, 2024

(54) PORTABLE ANKLE MONITOR DEVICE

(71) Applicant: Johnston L. Watson, Aventura, FL (US)

(72) Inventor: Johnston L. Watson, Aventura, FL (US)

(21) Appl. No.: 17/864,921

(22) Filed: Jul. 14, 2022

(51) Int. Cl. G08B 21/02; G01S 19/14

(52) U.S. Cl. CPC G08B 21/0269; G01S 19/14

(57) ABSTRACT

The present invention discloses an improved ankle monitor device of an enhanced portable size having an efficient charging feature, which is particularly designed for personal safety and tracking of an individual without any interruption. The ankle monitoring device comprises a portable electronic module securely attached with an anti-tamper silicone strap, and an attachment means with a USB charging port to externally charge the ankle monitoring device. The main purpose of the present invention is to facilitate a timely and accurate tracking of an individual without any discontinuation due to a shorter battery life, hence to check on the individual's movement and health without interruption.

### CROSS-REFERENCE TO RELATED APPLICATIONS

This application claims the benefit of U.S. Provisional Application No. 63/156,578, filed on Mar. 4, 2021.

### FIELD OF THE INVENTION

The present invention relates primarily to a field of ankle monitors, and more particularly it relates to a unique and improved ankle monitor device of an enhanced portable size with an efficient charging, which is designed specifically for personal safety and tracking of an individual and is easy to use by the individual without any discontinuation, thereby to uninterruptedly monitor the individual.

### BACKGROUND OF THE INVENTION

Ankle monitors and monitoring bracelets are widely utilized to track individuals. They are most commonly used by the justice system to monitor the individuals with pending criminal charges released from jail on bail, facilitate monitoring the individuals on home arrest, and monitoring the individuals on parole or probation. In recent years, the ankle monitors have also been used in monitoring of the individuals with mental impairments such as Alzheimer or dementia.

Over the course of time, various tracking and monitoring devices have been invented to monitor or track persons that are subject to restricted movements. Moreover, various prior arts have been disclosed in order to attempt and solve the aforesaid problem. A prior art US20220068104A1 to Lee Wilson, discloses a tracking and monitoring system and method which include a callback engine in communication with a plurality of GNSS-enabled ankle monitor bracelets via cellular/Wi-Fi internet service or SMS text service, depending on availability of services at each bracelet location. The bracelets include advanced power saving circuitry and notify the callback engine of low battery levels. An administration application allows efficient management of bracelets by law enforcement authorities and may communicate with bracelet wearers via the callback engine or a mobile phone application. However, the ankle monitor bracelet of Lee does not address anything about the portability of device.

A prior art U.S. Ser. No. 10/984,645B2 to Mark Wojci et al., describes a novel security band which can be used in conjunction with a commercially available smartwatch. The security band is able to detect if it is cut or removed and is able to wirelessly notify a smartwatch or optional smartphone. The notification is then relayed to a monitoring center or supervising authority using a cellular telephone network or other wireless communication method. However, the Mark mainly focuses on tamper or removal detection of the security band, and silent about portability feature and other advanced features. As a matter of fact, the limitations of the abovementioned invention of the Lee have not been overcome by the invention of the Mark.

Another prior art U.S. Pat. No. 7,619,513B2 to Maurice L. Hill et al, describes a body worn device for monitoring movement of an object, wherein the device comprises a first module configured to secure to the object, a second module capable of electrically connecting to the first module, includes at least a rechargeable battery and a memory capable of storing a history of movement data, and a third module capable of electrically connecting with the second module includes a data modem capable of connecting to a remote station, and a battery charger. The Maurice focuses on recording the movement of individuals using GPS signals for later comparison with event data to determine if the individual was in the vicinity of the event within a given time frame. However, this patent does not disclose anything about portability of the device and other advanced features.

Another prior art US20070171047A1 to Gregory Goodman et al., discloses a status device and system that enables a person, animal, or object to be identified, located and a status to be determined using location and tracking technologies. The status device can be in the form of a wristband. The status device can include a variety of components including a GPS antenna array which receives the GPS ranging signals transmitted from the GPS satellites positioned in the sky above the status device.

Another prior art US20220084386A1 to Linda Diane Flores Lopez, introduces a device which has an inner and outer base control module with a multifunctioning sensor tracking system comprising multiple elements with varied housing, color, designs, and shapes. The device housing can have diverse distinct differences ranging from but not limited to wrist or bracelet, shapes, rings cell phones, buttons, square or rectangular wall and desk top models for seniors, all with components information, recording and control requirements. The device has the power source within the housed unit which can be solar, electric, battery or as technology advances according to the designs dictated by skilled experts.

Although there is a plurality of tracking and monitoring devices available in the market in order to monitor or track displacements of the individuals, they do not adequately solve or render a viable solution to the current problem. Based on the prior arts research as described above, the vast majority of the tracking and monitoring devices do not have an enhanced portable size. Also, some devices are heavy in weight and require frequent charging.

The applicant is unaware of any such monitoring devices which have the enhanced portable size. Moreover, there is no such ankle monitoring device known in the prior arts that has a lightweight and flexible design and is easy to use by the person without any discontinuation due to lack of charging. In addition, there is no such ankle monitoring device known in the prior arts that has the advanced features disclosed by the present invention in following description.

The conventional ankle monitoring devices encounter various problems and are provided with quite an inflexible configuration. On the other hand, the present invention discloses a practical solution via an improved ankle monitoring device with a plurality of advanced features disclosed hereinafter. The unique characteristics and features of the present invention are, therefore, unrepresented within the conventional ankle monitoring devices. Hence, the present invention has been disclosed to provide solutions to the aforementioned needs, and to resolve the aforementioned deficiencies in the conventional monitoring methods and apparatuses.

### SUMMARY OF THE INVENTION

The present invention concerns improvements in and relating to an ankle monitoring device, and discloses the ankle monitoring device of an enhanced portable size having an efficient charging feature, which is designed specifically for personal safety and tracking of an individual without any interruption. The ankle monitoring device comprises: a portable electronic module securely attached with an anti-tamper silicone strap hence to be firmly worn around an ankle or a wrist of a user, and an attachment means with a USB charging port to externally charge the ankle monitoring device to maintain a continuous power supply.

Therefore, the primary objective of the present invention is to provide an improved ankle monitoring device which addresses the needs which were not fulfilled by the conventional ankle monitoring devices.

Another objective of the present invention is to provide an ankle monitoring device which includes a built-in rechargeable battery system to allow uninterrupted operation.

Still another objective of the present invention is to provide an ankle monitoring device which includes a built-in light system to maintain a uniform light source while at night.

Still another objective of the present invention is to provide an ankle monitoring device which includes a power source switch to control a built-in light system.

Still another objective of the present invention is to provide an ankle monitoring device which includes a thin compact size strap with universal adjustable size for all adults and kids.

Still another objective of the present invention is to provide an ankle monitoring device which includes an automatic sensing module for sensing changes in, but not limited to, voice, pulse, emotions, impact, motion, and device state.

Still another objective of the present invention is to provide an ankle monitoring device which employs a GPS enabled tracking module which is in communication with a monitor/control center.

Still another objective of the present invention is to provide an ankle monitoring device which includes a processor that controls the operation of various components of the ankle monitoring device.

Still another objective of the present invention is to provide an ankle monitoring device which includes a display module to indicate battery status.

Still another objective of the present invention is to provide an ankle monitoring device which includes a recording module for photo, audio and video recording and can play back the recorded data.

Still another objective of the present invention is to provide an ankle monitoring device which includes a self-protection module to stay guarded from attacks, such as, an electric shock, a pepper spray, and a blunt object.

Still another objective of the present invention is to provide an ankle monitoring device which includes an extendable strap to accompany extra size if required.

Still another objective of the present invention is to provide an ankle monitoring device which includes a communication component to facilitate easy connection with external electronic devices.

The summary is provided to introduce representative objectives of the invention in a simplified form that are further described below in the detailed description. This summary is not intended to identify key features or essential features of the claimed subject matter, nor is it intended to be used in any way that would limit the scope of the claimed subject matter.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 illustrates an exploded view of a portable ankle monitoring device, according to an embodiment of the present invention.

FIGS. 2a & 2b illustrate respective assembled views of a portable ankle monitoring device of FIG. 1, according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing disclosure has broadly outlined the features and technical advantages of the present disclosure in order that the description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or conducted in a variety of ways. It is to be understood that the phraseology and terminology employed herein is for the purpose of description and not of limitation.

It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “exemplary embodiment,” “an embodiment,” “an alternate embodiment,” “one embodiment,” “another embodiment,” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

As used herein, the terms “user” and “person” and “wearer” are interchangeable and refer to anyone who uses or wears a portable ankle monitoring device of the present invention i.e., a person on bail or home arrest or parole or probation, a medical patient.

As used herein, the term “strap” is merely related to, but not limited to, a strip of leather or other material worn around the waist or across the chest or ankle, especially in order to support clothes or carry weapons.

As used herein, the term “portable” is referred to be able to easily carried or moved, especially because of being a lighter and smaller version than usual.

As used herein, the term “LED” is merely referred to a light-emitting diode which is a semiconductor light source that emits light when current flows through it.

As used herein, the term “USB port” is merely referred to a type of serial port for connecting peripheral devices in a system.

As used herein, the term “battery” is merely referred as a device that stores energy and then discharges it by converting chemical energy into electricity. Typical batteries most often produce electricity by chemical means through the use of one or more electrochemical cells.

The present invention hereby discloses an improved ankle monitor device which is highly portable in size and facilitated with an efficient charging feature. The ankle monitor device of the present invention is particularly designed for personal safety and tracking of an individual without causing any discontinuation due to a shorter battery life, hence to monitor the individual's movement and health without interruption.

Reference will now be made in detail to preferred embodiments of the present invention, an example of which is illustrated in the accompanying drawings.

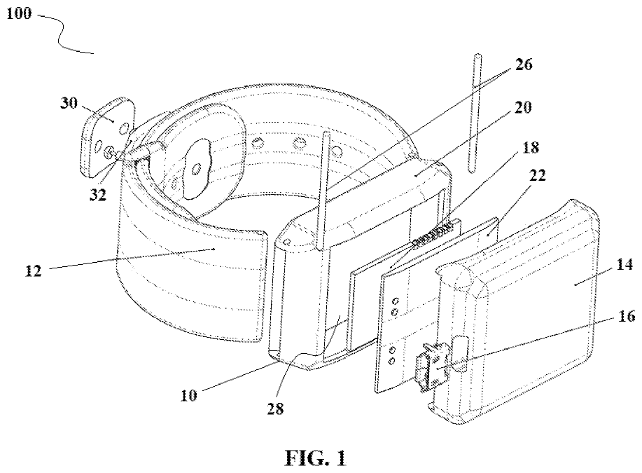

According to a preferred embodiment of the present invention, an exploded view of an ankle monitor device 100 is shown in FIG. 1. Turning to FIG. 1, the ankle monitor device 100 comprising: a portable electronic module 10 securely connected to an anti-tamper silicone strap 12 in order to be firmly worn around an ankle or a wrist of a user; and an attachment means 14 with a USB charging port 16 adapted to externally charge a built-in rechargeable battery 18 located therein the portable electronic module 10 in order to maintain a continuous power supply.

Further referring to FIG. 1, the portable electronic module 10 comprising a plurality of components supported by a housing 20, wherein the components include, the built-in rechargeable battery 18 adapted to supply uninterrupted power to the portable electronic module an automatic sensing module (it is understood to be concealed) configured to detect changes in, but not limited to, voice, pulse, emotions, impact, motion and the device state; a GPS enabled tracking module (it is understood to be concealed) adapted to: track and manage the user who is quarantined at home, track and manage the user with Alzheimer to check their location and health information, and get alert and notification when some emergency happens; a display module 22 adapted to indicate battery status; a live tracking indicator 24 located on the display module 22, adapted to ensure active status of the device; a recording module (it is understood to be concealed) adapted to record photo, audio and video and to play back the recorded data; a self-protection module (it is understood to be concealed) adapted to protect the ankle monitor device 100 from attack i.e. electric shock, pepper spray, blunt object; a communication component adapted to facilitate easy connection with external electronic devices selected from, but not limited to, a computer, a mobile phone, a speaker etc.; a processor (it is understood to be concealed) operably connected with all the components within the housing 20 and configured to control the operation of the components; a pair of PCB timers 26; and a battery placement 28 adapted to accommodate the built-in rechargeable battery 18 therein.

According an embodiment of the present invention, the built-in rechargeable battery 18 is highly compact in size, and configured to be charged by a solar panel located therein. Further, the built-in rechargeable battery 18 is also configured to be charged from an external power source by connecting a USB power cord to the USB charging port 16 of the attachment means 14.

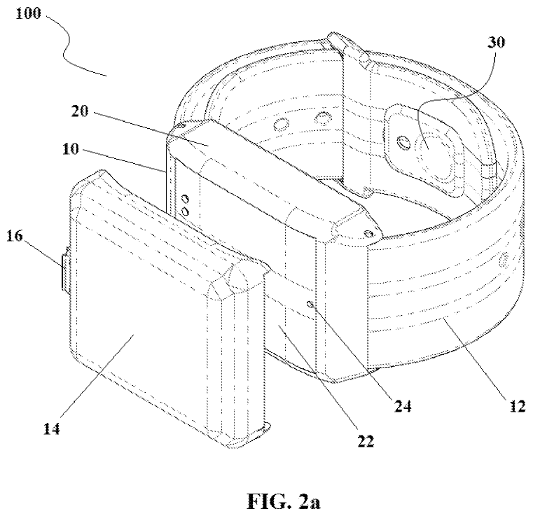

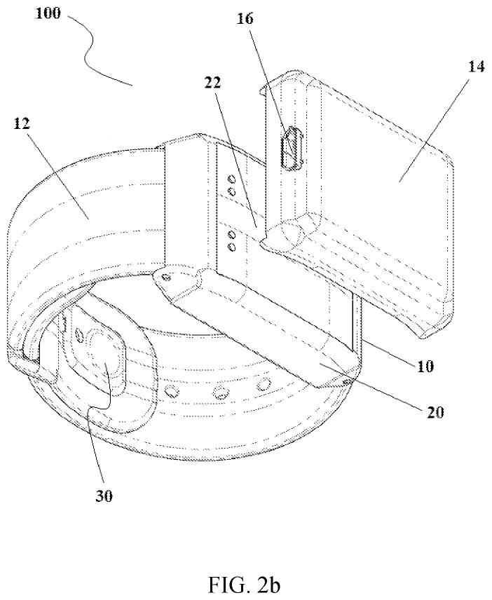

According to another embodiment of the present invention, FIGS. 2a & 2b depict assembled views of the ankle monitor device 100. In FIGS. 2a & 2b, the portability of the ankle monitor device 100 is clearly shown. An ergonomic design of the ankle monitor device 100 allows a comfortable fit on the ankle as well as wrist based on the requirements. In addition, FIGS. 2a & 2b show the attachment means 14 which is removably attached over the display module 22 while charging the ankle monitor device 100 from the external power source. Since the attachment means 14 is an external part of the ankle monitor device 100 and required only during the charging from the external sources, it makes the ankle monitor device 100 quite lightweight and flexible.

According an embodiment of the present invention, the portable electronic module 10 can be connected with the external electronic devices via the communication component wherein data and other information may be downloaded to the portable electronic module 10 from a remote location. Data recorded by the recording module of the portable electronic module 10 can also be uploaded to the external electronic devices and then the remote site. The communication component is selected from, but not limited to, WIFI, Bluetooth, etc.

The processor is operably connected to the other input components of the portable electronic module 10 as understood by those skilled in the art. The processor includes software in cooperation with the input components. The components of the processor are contained within and supported by the housing 20. The processor includes various electrical components including a rechargeable power supply (e.g., rechargeable battery or other battery types) and system memory. The processor will also include an antenna, allowing the processor and the portable electronic module 10 to communicate with the automatic sensing module, the recording module, and the GPS enabled tracking module.

According an embodiment of the present invention, the GPS enabled tracking module is in communication with a monitor/control center via an Internet connection, and designed to include the safety and tracking features, wherein the GPS enabled tracking module is a multisensory wearable personal safety and/or tracking device that is capable of local and/or remote and/or activation which employs alert, assist and/or attack mechanisms to counter situations of emergency, problems or need faced by the wearer of the ankle monitor device 100. For instance, if the ankle monitor device 100 is damaged or violent demolition, a warning information will be sent automatically to the monitor/control center, and an appropriate action would be taken by a control officer on receipt of the alarm information. The other alerts include, but not limited to, emergency alert, strap cut-off alert, body temperature alert, etc.

Moreover, the monitor/control center receives location information via Global Positioning System, WIFI, Location Based Services, and keep more than 6 months of location history. In addition, the control officer can create geofence to receive alert when the offender and/or the medically impaired person exits or enters the geofence. The control officer can set the GPS interval from 1-30 minutes for different tracking modes.

Continue referring to FIG. 1, the anti-tamper silicone strap 12 comprising, a built-in light system (it is understood to be concealed) adapted to maintain uniform light source while at night; a power source switch adapted to control the built-in light system; a lock lid 30 made up of steel; and a pair of secure fit screws 32 made up of steel to securely lock the anti-tamper silicone strap 12. Further, an inside layer of the anti-tamper silicone strap 12 is made of metal and an outside layer is made of silicone or thermoplastic rubber (TPR). Once the ankle monitor device 100 is worn, it cannot be removed by the user due to the advanced locking mechanism. Only an authorized person can have access to unlock the ankle monitor device 100.

According an embodiment of the present invention, the built-in light system can be easily and efficiently manufactured and continuously operated using the solar panel or the built-in rechargeable battery 18. Further, the built-in light system is in the form of a tube and selected from a group of LED lights.

According an embodiment of the present invention, the anti-tamper silicone strap 12 is a thin compact size belt provided with a universal adjustable size for a large population including adults and kids. The comfort and reliability that is designed into the anti-tamper silicone strap 12 make it skin-friendly and unbreakable.

According an embodiment of the present invention, the anti-tamper silicone strap 12 is in the form of an extendable belt in order to accompany extra size if required.

According an embodiment of the present invention, the anti-tamper silicone strap 12 can be configured as an inlet for power sources for the built-in light system. In an alternative embodiment, the anti-tamper silicone strap 12 is designed in many different ways to receive the built-in light system and the related power sources therein, such as, but not limited to jewelry, watch, ring, necklace, bracelet, and the like.

According an embodiment of the present invention, the user can easily wear the ankle monitor device 100 underneath the clothes. The live tracking indicator 24 of the portable electronic module 10 is designed to blink and stay longer to identify the user wearing the ankle monitor device 100.

The ankle monitor device of the present invention is made up of highly rated waterproof material in order to get protection against water and liquids. The ankle monitor device is further protected against ingress of dust and airborne particles.

The improved ankle monitor device of the present invention is extremely beneficial and well applied as compared to the conventional ankle monitor devices. The simple and compact design of the ankle monitor device allows the user to wear it for a long time without need of frequent charging and without any physical discomfort. Also, the ankle monitor device is unique in that it is highly portable and has a self-charging feature as it keeps charging via the solar panel. Moreover, the present invention provides ergonomic design, which allows being used on wrist or ankle, according to the possibilities. The ankle monitor device of the present invention renders high precise positioning, multi-sensor tampering detection and industry-leading battery life, that ensure the highest level of security in offender monitoring industry. Most importantly, the present invention described herein aims to provide a solution that is practical, that can be implemented into a viable commercial success.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The invention has been explained in relation to specific embodiment. It is inferred that the foregoing description is only illustrative of the present invention, and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. An ankle monitor device, said device comprising:
an anti-tamper silicone strap, configured to be firmly worn around an ankle or a wrist of a user;
a portable electronic module securely connected to said anti-tamper silicone strap, said portable electronic module comprising a built-in rechargeable battery, an automatic sensing module, a GPS enabled tracking module, a display module, a live tracking indicator, a recording module, a self-protection module, a communication component, and a processor which is operably connected with aforesaid components of said portable electronic module and configured to control the operation of said components; and
an attachment means with a USB charging port, adapted to externally charge said built-in rechargeable battery located therein to maintain a continuous power supply.

2. The device of claim 1, wherein said built-in rechargeable battery is compact in size, and configured to be charged by a solar panel located therein.

3. The device of claim 1, wherein said portable electronic module can be connected with external electronic devices via a communication component selected from, but not limited to, WIFI, Bluetooth, etc.

4. The device of claim 1, wherein said processor includes software in cooperation with said components, and an antenna that allows said processor and said portable electronic module to communicate with said automatic sensing module, said recording module, and said GPS enabled tracking module.

5. The device of claim 1, wherein said GPS enabled tracking module is in communication with a control center via an Internet connection, and configured to employ alert, assist and/or attack mechanisms to counter situations of emergency, problems or need faced by the user.

6. The device of claim 1, wherein said anti-tamper silicone strap comprising a built-in light system adapted to maintain uniform light source while at night.

7. The device of claim 6, wherein said built-in light system can be easily and efficiently manufactured and continuously operated using said solar panel or said built-in rechargeable battery.

8. The device of claim 6, wherein said built-in light system is in the form of a tube and selected from a group of LED lights.

9. The device of claim 1, wherein said anti-tamper silicone strap comprising a power source switch adapted to control said built-in light system.

10. The device of claim 1, wherein said anti-tamper silicone strap comprising a lock lid made up of steel, and a pair of secure fit screws made up of steel to securely lock said anti-tamper silicone strap.

11. The device of claim 1, wherein said anti-tamper silicone strap is a thin compact size belt provided with an adjustable size for a large population including adults and kids.

12. The device of claim 1, wherein said anti-tamper silicone strap may be provided in the form of an extendable belt.

13. The device of claim 1, wherein said anti-tamper silicone strap may be designed in alternative ways selected from, but not limited to, jewelry, watch, ring, necklace, bracelet, and the like.
